(19) United States
(12) Patent Application Publication
(10) Pub. No.: US 2007/0298221 A1
(43) Pub. Date: Dec. 27, 2007

(54) Multi-ply fibrous structures and products employing same

(75) Inventor: Kenneth Douglas Vinson, Toone, TN (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/820,512

(22) Filed: Jun. 20, 2007

Related U.S. Application Data
(60) Provisional application No. 60/816,424, filed on Jun. 26, 2006.

(51) Int. Cl. D21H 27/40; B32B 5/26; B32B 27/04

(52) U.S. Cl. 428/154; 442/123; 442/381

(57) ABSTRACT

Multi-ply fibrous structures, products employing same and methods for making same are provided.

### CROSS REFERENCE TO RELATED APPLICATION

This application claims the benefit of U.S. Provisional Application No. 60/816,424 filed Jun. 26, 2006.

### FIELD OF THE INVENTION

The present invention relates to multi-ply fibrous structures, products employing same and methods for making same.

### BACKGROUND OF THE INVENTION

Formulators of prior art multi-ply fibrous structures and sanitary tissue products comprising same have most frequently oriented the plies of fibrous structures in the multi-ply fibrous structures to avoid having any “bumpy” side as an exterior, consumer contacting side, preferring to inwardly-face the bumpy side.

Thus, they have typically oriented the “flatter” side as the exterior, consumer contacting side.

However, some formulators of prior art multi-ply fibrous structures and sanitary tissue products comprising same have oriented the plies such that at least one “bumpy” side is an exterior, consumer contacting side of the multi-ply fibrous structures. In those cases, the outwardly facing orientation of the bumpy side has either been accompanied by a loss in softness or the necessity to erase the harshness of the bumps for example by depositing a chemical softener to smoothen the feel of the bumps.

The bumpy side is well known to have advantages in cleaning efficiency and/or in appearance. Accordingly, there is a need for a multi-ply fibrous structure and a sanitary tissue product comprising same having plies oriented such that at least one “bumpy” side is an exterior, consumer contacting side of the multi-ply fibrous structure, without the loss of softness relative to facing the bumpy side inward in the multi-ply fibrous structure.

### SUMMARY OF THE INVENTION

The present invention accomplishes this need by defining a multi-ply fibrous structure wherein at least one exterior surface of the multi-ply fibrous structure comprises one or more protuberance(s) (for example, the bump(s)). It has unexpectedly been found that a multi-ply fibrous structure that has an exterior surface comprising one or more protuberances (i.e., the “bumpy” side) wherein the protuberances define a mean spacing factor of from about 1.6 to about 4.2 provides an acceptable sanitary tissue product for consumers. While not being bound by theory, the structure is thought to be more flexible since the high modulus flatter surface is closer to the neutral bending axis of the structure while the lower modulus zone of the structure represented by the peaks of the protuberances is farthest away from the neutral axis. Further, such “bumpy” sides are not perceived by consumers as being too bumpy because the protuberances are so closely linked so that the surface feels “flat” to a consumer or the protuberances are independent enough from each other that a consumer's skin fails to contact multiple protuberances while the fibrous structure is being held or stroked against his/her skin.

In one example of the present invention, a multi-ply fibrous structure comprising an exterior surface comprising one or more protuberances wherein the one or more protuberances define a mean spacing factor between about 1.6 to about 4.2, is provided.

In another example of the present invention, a multi-ply sanitary tissue product comprising a multi-ply fibrous structure according to the present invention is provided.

In yet another example of the present invention, a method for making a multi-ply fibrous structure comprising the steps of combining a fibrous structure having a surface comprising one or more protuberances wherein the one or more protuberances define a mean spacing factor between about 1.6 to about 4.2 with another fibrous structure such that the surface comprising the one or more protuberances comprises an exterior surface of the multi-ply fibrous structure.

Accordingly, the present invention provides multi-ply fibrous structures having a “bumpy” exterior surface, multi-ply sanitary tissue products comprising same and methods for making same.

### BRIEF DESCRIPTION OF THE DRAWINGS

FIG. 1 represents a cross-sectional view of a fibrous structure ply suitable for inclusion in a multi-ply fibrous structure of the present invention;

FIG. 2 is a perspective representation of a multi-ply fibrous structure according to the present invention;

FIG. 3 is a cross-sectional view of FIG. 2 taken along line 3-3;

FIG. 4 is a perspective representation of another embodiment of a multi-ply fibrous structure according to the present invention;

FIG. 5 is a cross-sectional view of FIG. 4 taken along line 5-5;

FIG. 6 is a graph of Protuberance Frequency to Knuckle Area that illustrates the mean spacing factor defined by the protuberance(s) of the multi-ply fibrous structures of the present invention.

### DETAILED DESCRIPTION OF THE INVENTION

### Definitions

“Fibrous structure” as used herein means a structure that comprises one or more fibers. In one example, a fibrous structure according to the present invention means an orderly arrangement of fibers within a structure in order to perform a function. Nonlimiting examples of fibrous structures of the present invention include composite materials (including reinforced plastics and reinforced cement), paper, fabrics (including woven, knitted, and non-woven), and absorbent pads (for example for diapers or feminine hygiene products). A bag of loose fibers is not a fibrous structure in accordance with the present invention.

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), and multifunctional absorbent and cleaning uses (absorbent towels). The sanitary tissue product may be convolutedly wound upon itself about a core or without a core to form a roll of sanitary tissue product.

In one example, the sanitary tissue product of the present invention comprises a fibrous structure according to the present invention.

“Fiber” as used herein means an elongate particulate having an apparent length greatly exceeding its apparent width, i.e. a length to diameter ratio of at least about 10. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

Nonlimiting examples of suitable hardwood pulp fibers include tropical hardwood pulp fibers such as acacia fibers, eucalyptus fibers and various others, and mixtures thereof.

Nonlimiting examples of suitable softwood pulp fibers include Northern Softwood Kraft fibers (NSK) and Southern Softwood Kraft fibers (SSK).

In addition to the various wood pulp fibers, other cellulosic fibers such as cotton linters, rayon, and bagasse can be used in this invention. Synthetic fibers and/or non-naturally occurring fibers, such as polymeric fibers, can also be used. Nonlimiting examples of polymeric fibers include hydroxyl polymer fibers, with or without a crosslinking system. Nonlimiting examples of suitable hydroxyl polymers that make up hydroxyl polymer fibers include polyols, such as polyvinyl alcohol, polyvinyl alcohol derivatives, polyvinyl alcohol copolymers, starch, starch derivatives, chitosan, chitosan derivatives, cellulose, cellulose derivatives such as cellulose ether and ester derivatives, gums, arabinans, galactans, proteins and various other polysaccharides and mixtures thereof. For example, a fibrous structure of the present invention may comprise a continuous and/or substantially continuous fiber comprising a starch hydroxyl polymer and a polyvinyl alcohol hydroxyl polymer produced by dry spinning and/or solvent spinning (both unlike wet spinning into a coagulating bath) a composition comprising the starch hydroxyl polymer and the polyvinyl alcohol hydroxyl polymer. Other types of polymeric fibers include fibers comprising elastomeric polymers, polypropylene, polyethylene, polyester, polyolefin, and nylon. The polymeric fibers can be produced by spunbond processes, meltblown processes, and other suitable methods known in the art.

An embryonic fibrous web can be typically prepared from an aqueous dispersion of papermaking fibers, though dispersions in liquids other than water can be used. The fibers are dispersed in the carrier liquid to have a consistency of from about 0.1 to about 0.3 percent. It is believed that the present invention can also be applicable to moist forming operations where the fibers are dispersed in a carrier liquid to have a consistency of less than about 50% and/or less than about 10%.

“Protuberance” as used herein means a region of a surface that swells and/or bulges out from a surrounding or adjacent region of the surface. A protuberance may be of any shape and/or any height above the surface

“Bumpy side” or “Bumpy surface” as used herein means a surface that comprises one or more protuberances that define a mean spacing factor of from about 1.6 and/or from about 2.0 and/or from about 2.4 and/or from about 2.8 to about 4.2 and/or to about 3.8 and/or to about 3.4 and/or to about 3.0.

“Flat side” or “Flat surface” as used herein means a surface that lacks rounded protuberances.

“Flatter side” or “Flatter surface” as used herein means a surface characterized by less area of rounded protuberances compared to another surface.

“Mean spacing factor” or “MSF” as used herein is represented by the formula:

$$MSF = \frac{PF}{0.0125 \times {KA}^{2} - KA + 25.9}$$

wherein MSF is means spacing factor; PF is protuberance frequency, and KA is knuckle area.

“Protuberance frequency” or “PF” as used herein means the number of protuberance swells per lineal inch of travel across the fibrous structure surface (i.e. exterior surface). The protuberance swells may comprise different discrete protuberances and/or multiple encounters with a single protuberance turning back on itself (such a protuberance may be discrete or continuous). The Protuberance Frequency is likely to be different depending on the area of the fibrous structure surface selected for evaluation and the particular direction selected. This method should be applied to areas corresponding to circles having a diameter of 2.54 cm (1 inch). This is intended to correspond to a consumer holding and perhaps slowly stroking the product among her fingers as in evaluating it for softness or preparing to use it to wipe a spill or clean some part of her body, such as her nose or her perineum. With regard to selecting the direction to evaluate the Protuberance Frequency, one should inspect the 2.54 cm (1 inch) diameter area to be evaluated and determine the direction which would yield the highest Protuberance Frequency. The average of the Protuberance Frequency measured in this direction and the Protuberance Frequency measured in the direction perpendicular to this yields the Protuberance Frequency used to determine the mean spacing factor. The Protuberance Frequency is in units of in⁻¹.

“Knuckle area” or “KA” as used herein means the % of the total fibrous structure surface area (i.e., exterior surface) which is not a protuberance. For through-air dried products made by use of a Yankee, this corresponds to the area pressed against the Yankee at the point where the sheet is dry transferred. For a web wherein the protuberances are achieved via embossing, the knuckle area corresponds to the non-raised area of the male embossing roll. Knuckle Area is in units of %.

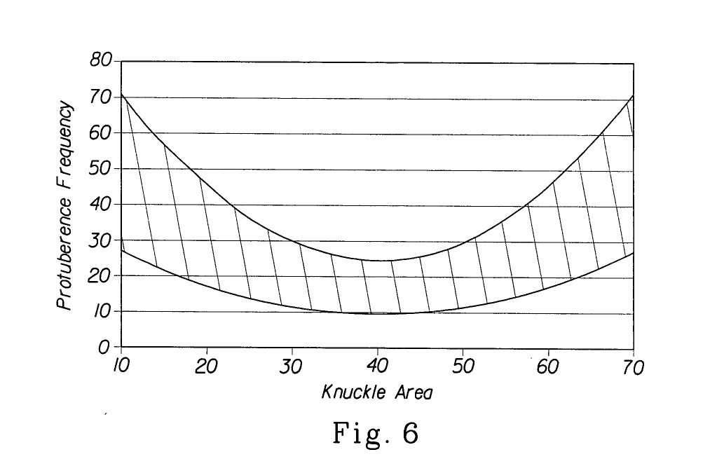

Fibrous structures having a mean spacing factor between about 1.6 and about 4.2 are visually represented in the graph plotting the Protuberance Frequency (in units of in⁻¹) versus the Knuckle Area (in units of %) as shown in FIG. 6. The shaded region between the two curves is the applicable zone. Only the range of 10% to 70% Knuckle Area are shown since this is the most applicable range of Knuckle Area.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Multi-Ply Fibrous Structure

The multi-ply fibrous structure comprises an exterior surface comprising one or more protuberances wherein the one or more protuberances define a mean spacing factor of from about 1.6 to about 4.2.

In one example, the multi-ply fibrous structure comprises at least one ply comprising at least one surface comprising one or more protuberances.

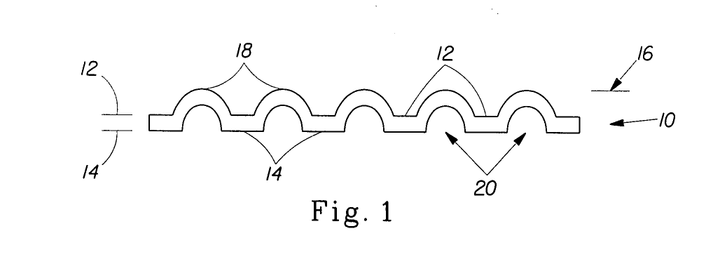

As shown in FIG. 1, an example of a ply, shown in cross-sectional view, that comprises one or more protuberances is shown. The ply 10 comprises a first surface, represented by line 12 and a second surface represented by line 14. The first surface 12 comprises one or more protuberances 18. The ply 10 also comprises a consumer contacting surface represented by line 16 which is created by the surfaces of the one or more protuberances 18. The consumer contacting surface 16 comprises at least one portion that protrudes above the first surface 12 of the ply 10. The one or more protuberances 18 on the first surface 16 define a mean spacing factor of from about 1.6 to about 4.2. Such a first surface 12 is utilized as the exterior surface of the multi-ply fibrous structure. The second surface 14 comprises one or more depressions 20. The one or more depressions 20 may be registered with one or more protuberances 18. It is obvious that if the second surface 14 was the exterior surface of a multi-ply fibrous structure, then the consumer contacting surface would be second surface 14. Therefore, it is clear that the first surface 12 and the second surface 14 can be and/or are different from one another.

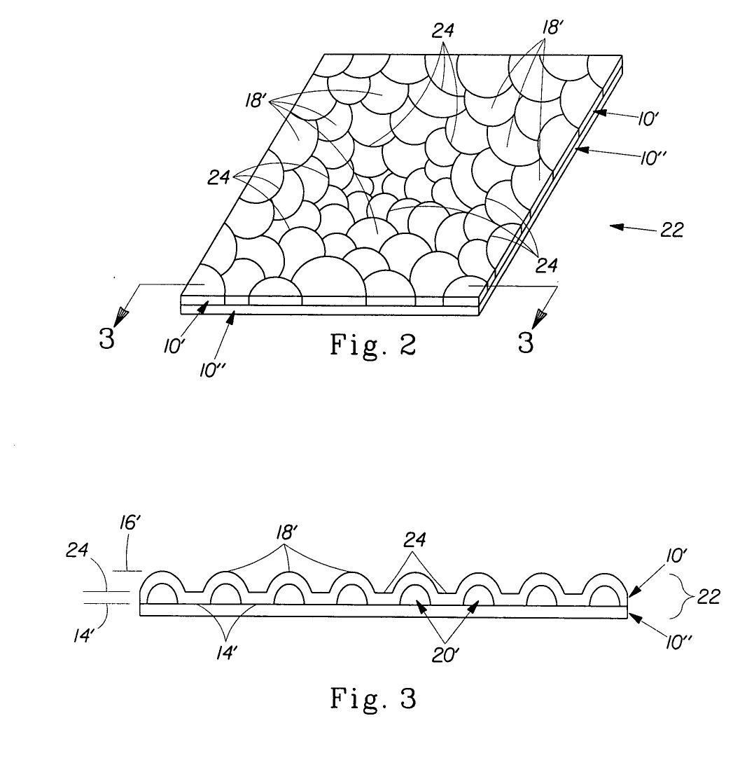

As shown in FIGS. 2 and 3, an example of a multi-ply fibrous structure 22 is shown. The multi-ply fibrous structure 22 comprises an exterior surface 24, which is represented by line 24 in FIG. 3. The exterior surface 24 comprises one or more protuberances 18′. The one or more protuberances 18′ define a mean spacing factor of from about 1.6 to about 4.2. The exterior surface 24 is a first surface of a fibrous structure ply 10′ of the multi-ply fibrous structure 22. The one or more protuberances 18′ create a consumer contacting surface represented by line 16′. The ply 10′ further comprises a second surface represented by line 14′. The second surface 14′ comprises one or more depressions 20′. The second surface 14′ is in physical contact with another fibrous structure ply 10″. Ply 10″ may be any suitable ply known in the art. It may be identical to ply 10′ or different from ply 10′. It may be oriented within the multi-ply fibrous structure 22 in such a way that its “bumpy side”, if any, forms an exterior surface of the multi-ply fibrous structure or forms and inner surface of the multi-ply fibrous structure.

In one example, the exterior surface of the multi-ply fibrous structure comprises tropical hardwood fibers, such as acacia fibers, eucalyptus fibers or mixtures thereof.

As shown in FIGS. 2 and 3, the protuberances 18′ are arranged in a discrete, random pattern of protuberances 18′ that are interrupted from one another by a continuous network of the exterior surface 24. In another example, the protuberances may be arranged in a discrete, non-random pattern of protuberances 18′ that are interrupted from one another by a continuous network of the exterior surface 24.

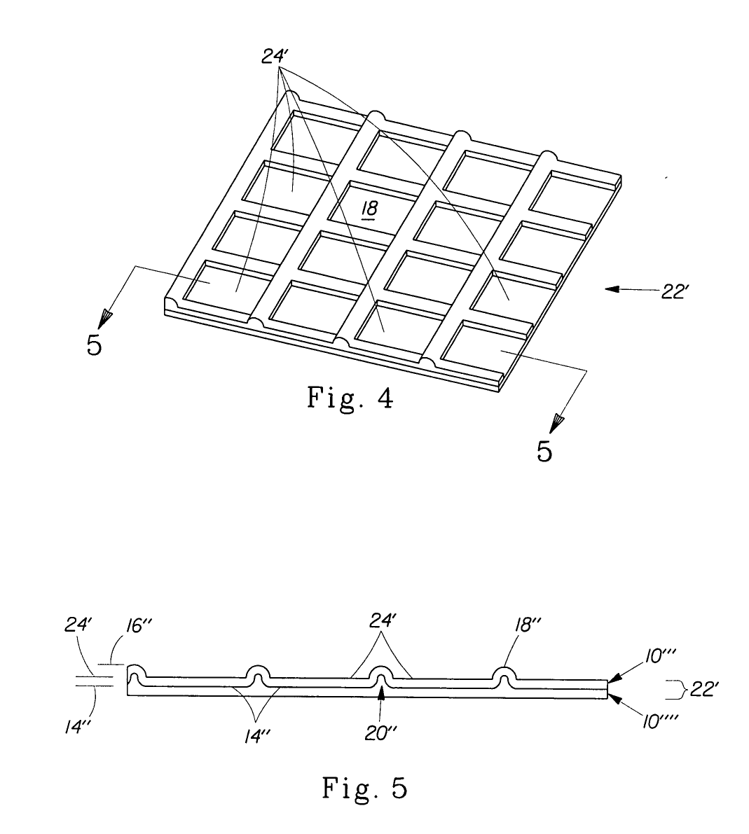

As shown in FIGS. 4 and 5, another example of a multi-ply fibrous structure 22′ is shown. The multi-ply fibrous structure 22′ comprises an exterior surface 24′, which is represented by line 24′ in FIG. 5. The exterior surface 24′ comprises one or more protuberances 18″, in this case, one protuberance 18″. The protuberance 18″ defines a mean spacing factor of from about 1.6 to about 4.2. The exterior surface 24′ is a first surface of a fibrous structure ply 10′″ of the multi-ply fibrous structure 22′. The protuberance 18″ creates a consumer contacting surface represented by line 16″. The ply 10′″ further comprises a second surface represented by line 14″. The second surface 14″ comprises one depression 20″. The second surface 14″ is in physical contact with another fibrous structure ply 10″″. Ply 10″″ may be any suitable ply known in the art. It may be identical to ply 10′″ or different from ply 10′″. It may be oriented within the multi-ply fibrous structure 22′ in such a way that its “bumpy side”, if any, forms an exterior surface of the multi-ply fibrous structure or forms and inner surface of the multi-ply fibrous structure.

As shown in FIGS. 4 and 5, the protuberance 18″ is arranged in continuous, non-random pattern. In other words, the protuberance 18″ is a continuous network. The protuberance 18″ defined discrete regions of the exterior surface 24′. In another example, the protuberance may be arranged in a continuous, non-random pattern.

As can be seen for the above description and the drawings, the second surface 14, 14′, 14″ define openings of the depressions 20, 20′, 20″.

The multi-ply fibrous structure comprises two or more fibrous structure plies. The plies may be bonded together by any suitable process and/or materials. Nonlimiting bonding processes can be by applying adhesive to bond the plies, embossing the plies together, and the like.

The protuberances may be low density regions compared to the exterior surface regions. The exterior surface regions may comprise fused fibers.

The inner surface of fibrous structure plies of the multi-ply fibrous structure may comprise a flat surface. The flat surface may be interrupted by one or more depressions. The flat surface may comprise a continuous network that at least partially defines openings for the one or more depressions. The flat surface may comprise a discontinuous network that at least partially defines openings for the one or more depressions.

The protuberances may lose less than 50% of their height when wetted (i.e., saturated with water), such as in the case of the protuberances being formed via a structure through-air-drying fabric. In another example, the protuberances may lose more than 50% of their height when wetted (i.e., saturated with water), such as in the case of the protuberances being embossments, such as embossments created during an embossing process.

The exterior surface of the multi-ply fibrous structure, especially a consumer contacting surface of the multi-ply fibrous structure, may comprise a softening agent and/or lotion.

The multi-ply fibrous structure may comprise one or more optional ingredients. Nonlimiting types of fibrous structures according to the present invention include conventionally felt-pressed fibrous structures; pattern densified fibrous structures; and high-bulk, uncompacted fibrous structures. The fibrous structures may be of a homogenous or multilayered (two or three or more layers) construction; and the sanitary tissue products made therefrom may be of a single-ply or multi-ply construction.

The fibrous structures and/or sanitary tissue products of the present invention may exhibit a basis weight of between about 10 g/m² to about 120 g/m² and/or from about 14 g/m² to about 80 g/m² and/or from about 20 g/m² to about 60 g/m².

The structures and/or sanitary tissue products of the present invention may exhibit a total (i.e. sum of machine direction and cross machine direction) dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in).

The fibrous structure and/or sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

In one example, the fibrous structure of the present invention is a pattern densified fibrous structure characterized by having a relatively high-bulk region of relatively low fiber density and an array of densified regions of relatively high fiber density. The high-bulk field is characterized as a field of pillow regions. The densified zones are referred to as knuckle regions. The knuckle regions exhibit greater density than the pillow regions. The densified zones may be discretely spaced within the high-bulk field or may be interconnected, either fully or partially, within the high-bulk field. Typically, from about 8% to about 65% of the fibrous structure surface comprises densified knuckles, the knuckles may exhibit a relative density of at least 125% of the density of the high-bulk field. Processes for making pattern densified fibrous structures are well known in the art as exemplified in U.S. Pat. Nos. 3,301,746, 3,974,025, 4,191,609 and 4,637,859.

The fibrous structures in accordance with the present invention may be in the form of through-air-dried fibrous structures, differential density fibrous structures, differential basis weight fibrous structures, wet laid fibrous structures, air laid fibrous structures (examples of which are described in U.S. Pat. Nos. 3,949,035 and 3,825,381), conventional dried fibrous structures, creped or uncreped fibrous structures, patterned-densified or non-patterned-densified fibrous structures, compacted or uncompacted fibrous structures, nonwoven fibrous structures comprising synthetic or multicomponent fibers, homogeneous or multilayered fibrous structures, double re-creped fibrous structures, foreshortened fibrous structures, co-form fibrous structures (examples of which are described in U.S. Pat. No. 4,100,324) and mixtures thereof.

In one example, the air laid fibrous structure is selected from the group consisting of thermal bonded air laid (TBAL) fibrous structures, latex bonded air laid (LBAL) fibrous structures and mixed bonded air laid (MBAL) fibrous structures.

The fibrous structures may exhibit a substantially uniform density or may exhibit differential density regions, in other words regions of high density compared to other regions within the patterned fibrous structure. Typically, when a fibrous structure is not pressed against a cylindrical dryer, such as a Yankee dryer, while the fibrous structure is still wet and supported by a through-air-drying fabric or by another fabric or when an air laid fibrous structure is not spot bonded, the fibrous structure typically exhibits a substantially uniform density.

### Surface Softening Agent

Surface softening agents include any chemical ingredient which imparts a lubricious feel to the fibrous structure and/or sanitary tissue product of the present invention and are present on a surface of the fibrous structure at a level greater than the remainder of the fibrous structure. Nonlimiting examples of suitable surface softening agents includes, for exemplary purposes only, basic waxes such as paraffin and beeswax silicone gels as well as petrolatum and more complex lubricants and emollients such as quaternary ammonium compounds with long (C8-C22) hydrocarbyl chains, functional silicones, and long (C8-C22) hydrocarbyl chain-bearing compounds possessing functional groups such as amines, acids, alcohols and esters.

Generally, surface softening agents are applied by their addition to the fibrous structure and/or sanitary tissue product after the fibrous structure and/or sanitary tissue product is partially or completely dried (for example less than 10% and/or less than 7% and/or less than 5% and/or less than 3% by weight of the fibrous structure (sanitary tissue product) of moisture). Applicable processes can be incorporated into the paper making operation as, for example, by spraying onto the embryonic web and/or dried fibrous structure before it is wound into a roll of paper, extruding, especially via slot extrusion, onto the embryonic web and/or dried fibrous structure, and/or by gravure printing onto the embryonic web and/or dried fibrous structure.

In one example, the surface softening agents are present on a surface of the fibrous structure such that the surface softening agent is contacted by a user's skin during use. In another example, the surface softening agent may comprise a transferable ingredient and/or composition that is capable of transferring to a user's skin during use. Considerable art has been devised to apply chemical softeners to already-dried paper webs either at the so-called dry end of the papermaking machine or in a separate converting operation subsequent to the papermaking step. Exemplary art from this field includes U.S. Pat. Nos. 5,215,626, 5,246,545 and 5,525,345.

Nonlimiting examples of suitable surface softening agents and processes for applying same to fibrous structures are described in U.S. Pat. Nos. 6,855,229, 6,797,117, 6,755,939, 6,607,637, 6,547,928 and U.S. Patent Publication No. 2004/0255396 A1.

In one example, a surface softening agent comprises a quaternary ammonium softener, an emollient lotion and/or a polysiloxane or silicone.

### Optional Ingredients

In addition to the bulk softening agent, and optionally the surface softening agent and/or surfactant, the fibrous structures of the present invention may further comprise additional optional ingredients selected from the group consisting of permanent and/or temporary wet strength resins, dry strength resins, wetting agents, lint resisting agents, absorbency-enhancing agents, antiviral agents including organic acids, antibacterial agents, polyol polyesters, antimigration agents, polyhydroxy plasticizers and mixtures thereof. Such optional ingredients may be added to the fiber furnish, the embryonic fibrous web and/or the fibrous structure.

Such optional ingredients may be present in the fibrous structures at any level based on the dry weight of the fibrous structure.

The optional ingredients may be present in the fibrous structures at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

### Method for Making a Multi-Ply Fibrous Structure

The multi-ply fibrous structure of the present invention and the one or more fibrous structure plies making up the multi-ply fibrous structure may be made by any suitable process known to those skilled in the art. The protuberance(s) on the exterior surface of the multi-ply fibrous structure may be made during papermaking and/or during converting. One or more fibrous structure plies of the multi-ply fibrous structure may be made by wet-laid processes and/or air-laid processes. Further, one or more fibrous structure plies of the multi-ply fibrous structure may be made by meltblown, spunbond or other polymer processing processes that form fibrous structures.

The protuberance(s) of the multi-ply fibrous structure may be made by any suitable process known in the art. For example, the protuberance(s) may be made via a structured through-air-dried fabric during papermaking. In another example, the protuberance(s) may be made by a suitable embossing process. In still another example, the protuberance(s) may be made by a foreshortening process, creping process, rush transfer process and the like. Still further yet, the protuberance(s) may be made by any suitable tuft generating process known in the art.

The two or more fibrous structure plies of the multi-ply fibrous structure may be combined to form the multi-ply fibrous structure by any suitable process known in the art.

In one example, a method for making a multi-ply fibrous structure comprising the steps of combining a fibrous structure having a surface comprising one or more protuberances wherein the one or more protuberances define a mean spacing factor between about 1.6 to about 4.2 with another fibrous structure such that the surface comprising the one or more protuberances comprises an exterior surface of the multi-ply fibrous structure.

### NONLIMITING EXAMPLES

### Example 1

This Example illustrates a process for making a multi-ply sanitary tissue product (i.e., a bathroom tissue) according to the present invention using a through-air dried process.

An aqueous slurry of Northern Softwood Kraft (NSK) of about 3% consistency is made up using a conventional pulper and is passed through a stock pipe toward the headbox of the Fourdrinier. A dispersion of Parez 750C wet strength resin about 1% in concentration is mixed with this stock in an amount sufficient to deliver a total of about 3 lb of resin per ton of finished paper product. Distribution of the Parez 750C is aided by an in-line mixer. This wet strength resin treated stock is diluted at the inlet of a first fan-pump with recycled white water to a consistency of about 0.2%.

An aqueous slurry of acacia fibers (from Riau Andalan—Indonesia) of about 3% by weight is made up using a conventional repulper. The acacia slurry passes to the second fan pump where it is diluted with white water to a consistency of about 0.2%.

The slurries of NSK and acacia are directed into a multi-channeled headbox suitably equipped with layering leaves to maintain the streams as separate layers until discharged onto a traveling Fourdrinier wire. A three-chambered headbox is used. The acacia slurry containing 70% of the dry weight of the ultimate paper is directed to the chambers leading to the two outer layers, while the NSK slurry comprising 30% of the dry weight of the ultimate paper is directed to the chamber leading to the center layer. The NSK and acacia slurries are combined at the discharge of the headbox into a composite slurry.

The composite slurry is discharged onto the traveling Fourdrinier wire and is dewatered assisted by a deflector and vacuum boxes. The embryonic wet web is transferred from the Fourdrinier wire, at a fiber consistency of about 17% by weight at the point of transfer, to a patterned drying fabric. The drying fabric is designed to yield a pattern-densified tissue with discontinuous low-density deflected areas arranged within a continuous network of high density (knuckle) areas. This drying fabric is formed by casting an impervious resin surface onto a fiber mesh supporting fabric. The supporting fabric is a 48×52 filament, dual layer mesh. The thickness of the resin cast is about 12 mil above the supporting fabric. The knuckle area is about 40% and the open cells remain at a frequency of about 400 per square inch. The open cells are generally elliptical in shape with the longer direction disposed in the machine direction and having an aspect ratio of 0.866.

Further de-watering is accomplished by vacuum assisted drainage until the web has a fiber consistency of about 22% by weight. While remaining in contact with the patterned forming fabric, the patterned web is pre-dried by air blow-through pre-dryer to a fiber consistency of about 58% by weight.

The semi-dry web is then adhered to the surface of a Yankee dryer with a sprayed creping adhesive comprising a 0.250% aqueous solution of polyvinyl alcohol. The creping adhesive is delivered to the Yankee surface at a rate of 0.1% adhesive solids based on the dry weight of the web.

The fiber consistency is increased to about 98% by weight before the web is dry creped from the Yankee with a doctor blade. The doctor blade has a bevel angle of about 20° and is positioned with respect to the Yankee dryer to provide an impact angle of about 76°. The Yankee dryer is operated at a temperature of about 350° F. (177° C.) and a speed of about 800 fpm (feet per minute) (about 244 meters per minute). The paper is wound in a roll using a surface driven reel drum having a surface speed of about 680 fpm (about 207 meters per minute), thus resulting in a crepe of about 15%.

After the doctor blade, the web is calendered across all its width with a steel to rubber calendar roll to achieve the caliper desired in the product. Resulting fibrous structure has a basis weight of about 20 g/m2; a 1-ply total dry tensile between 250 and about 300 g/in, a 1-ply initial total wet tensile between about 30 and about 35 g/in and a 1-ply caliper of about 0.018 inches. Resulting fibrous structure is then plied together with a like sheet to form a two-ply, creped, pattern densified fibrous structure so that the Yankee-contacting surface, which is the flatter surface, of each ply faces inward while the non-Yankee contacting surface face outward. The plies are minimally tacked together using about ½″ wide stripe of hot melt adhesive to prevent the plies from easily separating. The resulting two-ply fibrous structure has a) a total basis weight of about 40 g/m2 and a caliper of about 0.028 inches.

### Example 2

This Example illustrates a process for making a multi-ply sanitary tissue product (i.e., a bathroom tissue) according to the present invention using a through-air dried process without the use of a Yankee dryer.

An aqueous slurry of Northern Softwood Kraft (NSK) of about 3% consistency is made up using a conventional pulper and is passed through a stock pipe toward the headbox of the Fourdrinier. A dispersion of Parez 750C wet strength resin about 1% in concentration is mixed with this stock in an amount sufficient to deliver a total of about 3 lb of resin per ton of finished paper product. Distribution of the Parez 750C is aided by an in-line mixer. This wet strength resin treated stock is diluted at the inlet of a first fan-pump with recycled white water to a consistency of about 0.2%.

An aqueous slurry of acacia fibers (from Riau Andalan—Indonesia) of about 3% by weight is made up using a conventional repulper. The acacia slurry passes to the second fan pump where it is diluted with white water to a consistency of about 0.2%.

The slurries of NSK and acacia are directed into a multi-channeled headbox suitably equipped with layering leaves to maintain the streams as separate layers until discharged onto a traveling Fourdrinier wire. A three-chambered headbox is used. The acacia slurry containing 70% of the dry weight of the ultimate paper is directed to the chambers leading to the two outer layers, while the NSK slurry comprising 30% of the dry weight of the ultimate paper is directed to the chamber leading to the center layer. The NSK and acacia slurries are combined at the discharge of the headbox into a composite slurry.

The composite slurry is discharged onto the traveling Fourdrinier wire and is dewatered assisted by a deflector and vacuum boxes. The embryonic wet web is transferred from the Fourdrinier wire, at a fiber consistency of about 25% by weight at the point of transfer, to a patterned drying fabric. The drying fabric is designed to yield a pattern-densified tissue with discontinuous low-density deflected areas arranged within a continuous network of high density (knuckle) areas. This drying fabric is formed by casting an impervious resin surface onto a fiber mesh supporting fabric. The supporting fabric is a 48×52 filament, dual layer mesh. The thickness of the resin cast is about 12 mil above the supporting fabric. The knuckle area is about 40% and the open cells remain at a frequency of about 400 per square inch. The open cells are generally elliptical in shape with the longer direction disposed in the machine direction and having an aspect ratio of 0.866.

The Fourdrinier wire is overdriven by about 25% relative to the speed of the patterned drying fabric. This imparts a machine direction compaction to the web and the foreshortening introduces the equivalent of crepe into the sheet so that a Yankee dryer is not needed for creping.

While remaining in contact with the patterned forming fabric, the patterned web is completely dried by air blow-through to a fiber consistency of about 98% by weight at which point it is removed from the drying fabric and conveyed to a reel where it is wound into a parent roll.

After removing from the drying fabric, the web is calendered across all its width with a steel to rubber calendar roll to achieve the caliper desired in the product. Resulting fibrous structure has a basis weight of about 20 g/m2; a 1-ply total dry tensile between 250 and about 300 g/in, a 1-ply initial total wet tensile between about 30 and about 35 g/in and a 1-ply caliper of about 0.018 inches. Resulting fibrous structure is then plied together with a like sheet to form a two-ply, creped, fibrous structure so that the drying fabric-contacting surface, which is the protuberance-laden surface of each ply faces outward while the non-drying fabric contacting surfaces (which are flatter) face inward. The plies are minimally tacked together using about ½″ wide stripe of hot melt adhesive to prevent the plies from easily separating. The resulting two-ply fibrous structure has a) a total basis weight of about 40 g/m2 and a caliper of about 0.028 inches.

### Example 3

This Example illustrates a process for making a multi-ply sanitary tissue product (i.e., a bathroom tissue) according to the present invention using a conventional papermaking process combined with embossing.

An aqueous slurry of Northern Softwood Kraft (NSK) of about 3% consistency is made up using a conventional pulper and is passed through a stock pipe toward the headbox of the Fourdrinier. A dispersion of Parez 750C wet strength resin about 1% in concentration is mixed with this stock in an amount sufficient to deliver a total of about 3 lb of resin per ton of finished paper product. Distribution of the Parez 750C is aided by an in-line mixer. This wet strength resin treated stock is diluted at the inlet of a first fan-pump with recycled white water to a consistency of about 0.2%.

An aqueous slurry of acacia fibers (from Riau Andalan—Indonesia) of about 3% by weight is made up using a conventional repulper. The acacia slurry passes to the second fan pump where it is diluted with white water to a consistency of about 0.2%.

The slurries of NSK and acacia are directed into a multi-channeled headbox suitably equipped with layering leaves to maintain the streams as separate layers until discharged onto a traveling Fourdrinier wire. A three-chambered headbox is used. The acacia slurry containing 70% of the dry weight of the ultimate paper is directed to the chambers leading to the two outer layers, while the NSK slurry comprising 30% of the dry weight of the ultimate paper is directed to the chamber leading to the center layer.

The composite slurry is discharged onto the traveling Fourdrinier wire and is dewatered assisted by a deflector and vacuum boxes. The embryonic wet web is transferred from the Fourdrinier wire, at a fiber consistency of about 17% by weight at the point of transfer, to a conventional felt. Further de-watering is accomplished by passing the felt through a conventional wet press. The semi-dry web is then adhered to the surface of a Yankee dryer aided by a sprayed creping adhesive comprising a 0.250% aqueous solution of polyvinyl alcohol. The creping adhesive is delivered to the Yankee surface at a rate of 0.1% adhesive solids based on the dry weight of the web.

The fiber consistency is increased to about 98% by weight before the web is dry creped from the Yankee with a doctor blade. The doctor blade has a bevel angle of about 20° and is positioned with respect to the Yankee dryer to provide an impact angle of about 76°. The Yankee dryer is operated at a temperature of about 350° F. (177° C.) and a speed of about 800 fpm (feet per minute) (about 244 meters per minute). The paper is wound in a roll using a surface driven reel drum having a surface speed of about 680 fpm (about 207 meters per minute), thus resulting in a crepe of about 15%.

Resulting fibrous structure has a basis weight of about 20 g/m2; a 1-ply total dry tensile between 250 and about 300 g/in, a 1-ply initial total wet tensile between about 30 and about 35 g/in and a 1-ply caliper of about 0.010 inches. Resulting fibrous structure is then plied together with a like sheet to form a two-ply, creped, pattern densified fibrous structure so that the Yankee-contacting surface of each ply faces outward while the non-Yankee contacting surface face inward. The plies are then passed through an embossing nip comprising a male roll of having uniform sized emboss elements uniformly spaced at a frequency of about 120/sq in. Each male element is essentially hemispherical in shape and engages matching female hemisphere recesses. The knuckle area on the roll is about 40%. The domes are approximately 0.020″ in height and engage about 0.015″ deep into the female pockets at maximum engagement. The engagement of the two rolls creates protuberances on one exterior surface of the two-ply web.

The resulting two-ply fibrous structure has a) a total basis weight of about 40 g/m2 and a caliper of about 0.024 inches.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-ply fibrous structure comprising an exterior surface comprising one or more protuberances wherein the one or more protuberances define a mean spacing factor between about 1.6 to about 4.2.

2. The fibrous structure according to claim 1 wherein the one or more protuberances comprise a consumer contacting surface.

3. The fibrous structure according to claim 1 wherein at least one ply of the fibrous structure comprises the exterior surface and an inner surface.

4. The fibrous structure according to claim 1 wherein the inner surface is different from the exterior surface.

5. The fibrous structure according to claim 4 wherein the inner surface comprises a flat surface interrupted by one or more depressions.

6. The fibrous structure according to claim 5 wherein the flat surface comprises a continuous network that at least partially defines openings for the one or more depressions.

7. The fibrous structure according to claim 5 wherein the flat surface comprises a discontinuous network that at least partially defines openings for the one or more depressions.

8. The fibrous structure according to claim 5 wherein the one or more depressions are registered with the one or more protuberances.

9. The fibrous structure according to claim 1 wherein the one or more protuberances lose less than 50% of their height when wetted.

10. The fibrous structure according to claim 1 wherein the one or more protuberances lose more than 50% of their height when wetted.

11. The fibrous structure according to claim 1 wherein the exterior surface comprises tropical hardwood fibers.

12. The fibrous structure according to claim 11 wherein the tropical hardwood fibers are selected from the group consisting of acacia fibers, eucalyptus fibers and mixtures thereof.

13. The fibrous structure according to claim 1 wherein the fibrous structure is a multi-ply sanitary tissue product.

14. The fibrous structure according to claim 13 wherein the exterior surface comprises a surface softening agent.

15. The fibrous structure according to claim 13 wherein the exterior surface comprises a lotion.

16. The fibrous structure according to claim 13 wherein the multi-ply sanitary tissue product comprises a bulk softening agent that is dispersed throughout the at least one of the fibrous structure plies making up the multi-ply sanitary tissue product.

17. The fibrous structure according to claim 13 wherein the multi-ply sanitary tissue product is convolutedly wound upon itself.

18. A method for making a multi-ply fibrous structure comprising the steps of combining a fibrous structure having a surface comprising one or more protuberances wherein the one or more protuberances define a mean spacing factor between about 1.6 to about 4.2 with another fibrous structure such that the surface comprising the one or more protuberances comprises an exterior surface of the multi-ply fibrous structure.

19. The method according to claim 18 wherein the method further comprises the step of imparting one or more protuberances to the fibrous structure.

20. The method according to claim 19 wherein the step of imparting one or more protuberances to the fibrous structure comprises the step of forming the fibrous structure on a structured through-air-drying fabric such that the one or more protuberances are formed.

21. The method according to claim 19 wherein the step of imparting one or more protuberances to the fibrous structure comprises the step of embossing the fibrous structure such that the one or more protuberances are formed.
